(19) United States
(12) Patent Application Publication
(10) Pub. No.: US 2026/0046219 A1
(43) Pub. Date: Feb. 12, 2026

(54) METHODS FOR COMMUNICATION

(71) Applicant: NEC Corporation, Tokyo (JP)

(72) Inventors: Gang WANG, Beijing (CN); Peng GUAN, Beijing (CN); Wei CHEN, Beijing (CN)

(73) Assignee: NEC Corporation, Tokyo (JP)

(21) Appl. No.: 19/102,114

(22) PCT Filed: Aug. 8, 2022
(86) PCT No.: PCT/CN2022/110897

§ 371 Date: Feb. 7, 2025

(51) Int. Cl. H04L 41/16; H04B 7/06; H04L 5/00

(52) U.S. Cl. CPC H04L 41/16; H04B 7/0626; H04L 5/0051

(57) ABSTRACT

Example embodiments of the present disclosure relate to methods, devices, and computer storage medium for communication. The method comprises: receiving, at a terminal device, at least one first set of Reference Signals (RSs) from a network device, the network device being deployed with at least one Artificial Intelligence/Machine Learning (AI/ML) model, and each of the at least one first set of RSs corresponding to one of the at least one AI/ML model; calculating, at the terminal device, at least one similarity based on the at least one first set of RSs; determining, at the terminal device, at least one similarity information based on the at least one calculated similarity, and at least one model information corresponding to the at least one similarity information, the at least one model information indicating an index of at least one AI/ML model; and transmitting, to the network device, at least one of: the at least one determined similarity information or the at least one model information.

### FIELD

Example embodiments of the present disclosure generally relate to the field of communication techniques and in particular, to methods, devices, and a computer readable medium for communication.

### BACKGROUND

Artificial Intelligence/Machine Learning (AI/ML) model is introduced for beam management (BM) in communication systems. For AI/ML model monitoring, the traditional approach is to compare predicted beam information and actual beam information. Such an approach requires a terminal device (also referred to as “User Equipment”, “User Device” or UE) to measure a large amount of beam measurement reference signals (RSs) and report a large amount of beam information, which will cause huge overhead of beam measurement and reporting.

### SUMMARY

In general, example embodiments of the present disclosure provide methods, devices and a computer storage medium for communication, especially for reporting similarity information between training/predicted/preconfigured beam information and field/actual beam information.

In a first aspect, there is provided a method of communication. The method comprises: receiving, at a terminal device, at least one first set of RSs from a network device, the network device being deployed with at least one Artificial Intelligence/Machine Learning (AI/ML) model, and each of the at least one first set of RSs corresponding to one of the at least one AI/ML model; calculating, at the terminal device, at least one similarity based on the at least one first set of RSs; determining, at the terminal device, at least one similarity information based on the at least one calculated similarity, and at least one model information corresponding to the at least one similarity information, the at least one model information indicating an index of at least one AI/ML model; and transmitting, to the network device, at least one of: the at least one determined similarity information or the at least one model information.

In a second aspect, there is provided a method of communication. The method comprises: transmitting, at a network device, at least one first set of RSs to a terminal device, the network device being deployed with at least one Artificial Intelligence/Machine Learning (AI/ML) model, and each of the at least one first set of RSs corresponding to one of the at least one AI/ML model; receiving, from the terminal device, at least one of: at least one determined similarity information or at least one model information indicating an index of at least one AI/ML model; and determining whether the performance of at least one AI/ML model deteriorates.

In a third aspect, there is provided a terminal device. The terminal device comprises a processor and a memory storing computer program codes. The memory and the computer program codes are configured to, with the processor, cause the terminal device to perform the method of the first aspect.

In a fourth aspect, there is provided a network device. The network device comprises a processor and a memory storing computer program codes. The memory and the computer program codes are configured to, with the processor, cause the network device to perform the method of the second aspect.

In a fifth aspect, there is provided a computer readable medium having instructions stored thereon. The instructions, when executed by a processor of an apparatus, cause the apparatus to perform the method of the first or second aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1A illustrates an example communication system in which some embodiments of the present disclosure can be implemented;

FIG. 1B illustrates a schematic diagram of set of beams in accordance with some embodiments of the present disclosure;

FIG. 2 illustrates an example signaling chart in accordance with some example embodiments of the present disclosure;

FIG. 3 illustrates another example signaling chart in accordance with some example embodiments of the present disclosure;

FIG. 4 illustrates a third example signaling chart in accordance with some example embodiments of the present disclosure;

FIG. 5 illustrates a fourth example signaling chart in accordance with some example embodiments of the present disclosure;

FIG. 6 illustrates a fifth example signaling chart in accordance with some example embodiments of the present disclosure;

FIG. 7 illustrates a sixth example signaling chart in accordance with some example embodiments of the present disclosure;

FIG. 8 illustrates a seventh example signaling chart in accordance with some example embodiments of the present disclosure;

FIG. 9 illustrates a flowchart of an example method implemented at a terminal device in accordance with some embodiments of the present disclosure;

FIG. 10 illustrates a flowchart of an example method implemented at a network device in accordance with some embodiments of the present disclosure; and

FIG. 11 illustrates a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “terminal device” refers to any device having wireless or wired communication capabilities. Examples of terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also be incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

As used herein, the term “network device” refers to a device which is capable of providing or hosting a cell or coverage where terminal devices can communicate. Examples of a network device include, but not limited to, a satellite, a unmanned aerial systems (UAS) platform, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

Communications discussed herein may conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.85G, the third generation (3G), the fourth generation (4G), 4.5G, the fifth generation (5G), and the sixth (6G) communication protocols. The techniques described herein may be used for the wireless networks and radio technologies mentioned above as well as other wireless networks and radio technologies. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The terminal device or the network device may have Artificial intelligence (AI) or machine learning capability. It generally includes a model which has been trained from numerous collected data for a specific function, and can be used to predict some information.

The terminal device or the network device may work on several frequency ranges, e.g. FR1 (410 MHz-7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network device under Multi-Radio Dual Connectivity (MR-DC) application scenario. The terminal device or the network device can work on full duplex, flexible duplex and cross division duplex modes.

The embodiments of the present disclosure may be performed in test equipment, e.g., signal generator, signal analyzer, spectrum analyzer, network analyzer, test terminal device, test network device, or channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

In some communication systems, Artificial Intelligence (AI)/Machine Learning (ML) model(s) is (/are) used for beam management. If an AI/ML model is deployed at the network device for model monitoring (or validation, testing), the following operations are performed:

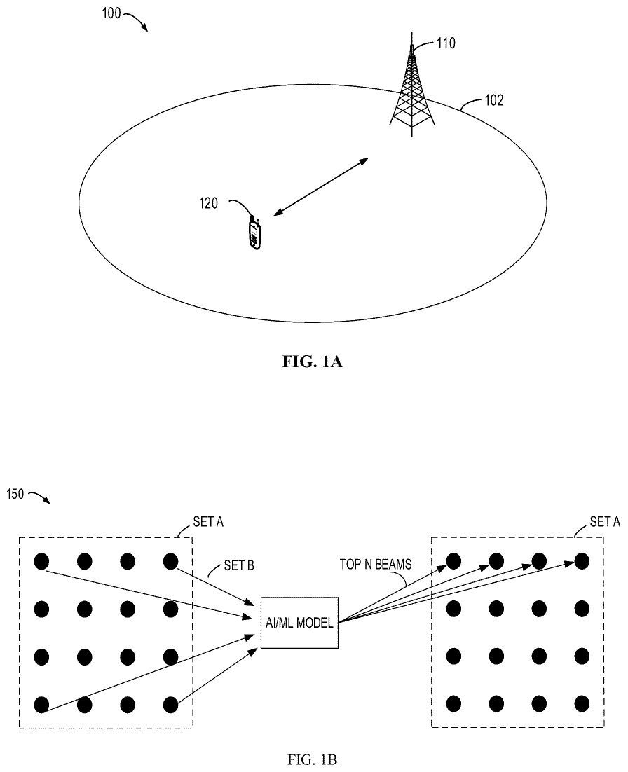

S1: the network device transmits Set A (and Set B) to the terminal device. The Set A and Set B will be described below with reference to FIG. 1B.

S2: the terminal device reports beam information to the network device, specifically, the beam information comprises at least one of: beam information of Set A, beam information of Set B and Set A, or beam information of Set B and top N beams out of Set A.

S3: Based on the reported beam information of Set B, the network device gets the predicted beam information by using AI/ML model. And the predicted beam information needs to be compared with the reported actual/measurement beam information, e.g., the estimated RSRPs, top N beams.

S4: the network device determines the AI/ML model performance based on the comparison results, i.e., difference between the predicted beam information and the actual/measurement beam information.

S5: if the AI/ML model performance deteriorates (e.g., the difference is larger than a threshold), model switching/updating (e.g., fine-tuning, re-training) can be considered, or, non-AI can be considered, by the network device.

As it can be seen from the above, for AI/ML model monitoring, the traditional approach is to compare predicted beam information and actual beam information. And, the above approach requires the terminal device to measure a large amount of beam measurement RSs and report a large amount of beam information, which will cause huge overhead of beam measurement and reporting.

Generally speaking, in the above AI/ML model monitoring scenario, AI/ML model learns “(historical) experience”. The “experience” consists of tens of thousands of training data. The training data has covered all possible realities as much as possible. However, due to the variability and randomness of the real environment, AI/ML model is still unable to deal with some “accidental” cases. Specifically, the data (i.e., field data corresponding to input of AI/ML model) may be “strange” to AI/ML model. In other words, AI/ML model may have not learned the “experience” corresponding to the field data, or the field data may be not similar with the (original) training data. In this case, the performance (e.g., generalization) of AI/ML model will decline (even deteriorate), which will reduce the accuracy of AI/ML model inference. Therefore, the similarity between the field data and the training data can be used to indirectly determine the performance (e.g., generalization) of AI/ML model. In other words, the similarity between field data and training data can be used as a metric to indirectly reflect the AI/ML model performance (e.g., generalization).

For model monitoring based on beam prediction, instead of the traditional approach (i.e., compare predicted beam information and actual beam information), we can determine the similarity between the field Set B and the training Set B to determine the AI/ML model performance. Unlike AI/ML model, the training data does not involve relevant algorithms, so it does not have privacy. Therefore, the relevant training data at the network device can be shared with the terminal device.

Then, the terminal device can obtain the training dataset (i.e., training Set B) through the network device, core network or edge cloud (or server, device) configuration or provision.

Considering that beam information is mainly RSRP, i.e., a real number, the algorithm for calculating the similarity between the field Set B and the training Set B is simple and easy to implement (the specific algorithm depends on the implementation of the terminal device). For beam prediction based on AI/ML model, the terminal device can determine the similarity between the field Set B and the training Set B.

In view of the above, at least for AI/ML model monitoring, in order to reduce the overhead of beam measurement and reporting, it can be considered that the terminal device reports only the similarity information between the field Set B and the training Set B to the network device. In this case, the terminal device can only measure the beams corresponding to the Set B instead of the Set A (it may mean that the network device needs to transmit only the Set B). And the terminal device can report only the similarity information instead of beam information of the beams corresponding to the Set B and the Set A or part of Set A.

FIG. 1A illustrates an example communication system 100 in which some embodiments of the present disclosure can be implemented. The communication system 100, which is a part of a communication network, includes a network device 110 and a terminal device 120.

The network device 110 can provide services to the terminal device 120, and the network device 110 and the terminal device 120 may communicate data and control information with each other. In some embodiments, the network device 110 and the terminal device 120 may communicate with direct links/channels.

In the system 100, a link from the network devices 110 to the terminal device 120 is referred to as a downlink (DL), while a link from the terminal device 120 to the network devices 110 is referred to as an uplink (UL). In downlink, the network device 110 is a transmitting (TX) device (or a transmitter) and the terminal device 120 is a receiving (RX) device (or a receiver). In uplink, the terminal device 120 is a transmitting (TX) device (or a transmitter) and the network device 110 is a RX device (or a receiver). It is to be understood that the network device 110 may provide one or more serving cells. As illustrated in FIG. 1, the network device 110 provides one serving cell 102, and the terminal device 120 camps on the serving cell 102. In some embodiments, the network device 110 can provide multiple serving cells. It is to be understood that the number of serving cell(s) shown in FIG. 1 is for illustrative purposes only without suggesting any limitation.

The communications in the communication system 100 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols.

It is to be understood that the number of devices and their connection relationships and types shown in FIG. 1 are for illustrative purposes only without suggesting any limitation. The communication system 100 may comprise any suitable number of devices adapted for implementing embodiments of the present disclosure.

It is to be noted that:

The term “Beam of a target signal” in this disclosure refers to, for example, QCL-TypeD (source) RS of the target signal.

The term “Beam information” in this disclosure refers to, for example, Beam identifier (ID) or (and) beam quality.

The term “Beam ID” in this disclosure refers to, for example, CSI-RS Resource Indicator (CRI) or SS/PBCH Block Resource Indicator (SSBRI).

The term “Beam quality” in this disclosure refers to, for example, Layer 1—Reference Signal Received Power (L1-RSRP), Layer 1-Signal to Interference plus Noise Ratio (L1-SINR), RSRP or SINR. Here, L1-RSRP can be equivalent to RSRP, and L1-SINR can be equivalent to SINR.

The term “QCL-TypeD” refers to, for example, spatial Rx parameters.

The term “Similarity” between A and B in this disclosure refers to, for example, a metric reflecting the distance or correlation or similarity (e.g., Euclidean distance, Minkowski distance, cosine similarity, Pearson correlation) between A and B. Generally, for example, the similarity may be a number between 0 and 1, e.g., 0, 0.1, 0.2, 0.3, 0.8, 0.9 and 1.

It is to be noted that, in this disclosure, “similarity” can be determined based on “dissimilarity” (or “diversity”, “difference”). Generally, the relationship between “similarity” and “dissimilarity” satisfies: similarity=1−dissimilarity.

It is to be noted that, in this disclosure, “similarity” or “similarity information” can be replaced with “dissimilarity” or “dissimilarity information”. Accordingly, the reporting and interpretation of the “dissimilarity information” by the terminal device 120 and the network device 110 should be opposite. For example, in some example embodiments, the indication can be used to indicate whether the Set B is not similar as the training Set B.

FIG. 1B illustrates a schematic diagram of set of beams in accordance with some embodiments of the present disclosure. Only for the purpose of discussion, the process 200 will be described with reference to FIG. 1. The process 200 may involve the terminal device 120 and network device 110.

As illustrated in FIG. 1B, an AI/ML model is deployed at the network device 110 as well as the set A. “set A” denotes a set of RSs (also referred to as “a set of beams” hereafter) deployed in the network device 110, and it comprises 16 beams in total. “set B” denotes another set of beams which is to be used in field measurements at the terminal device 120 for AI/ML model monitoring. In the example illustrated in FIG. 1B, set B comprises 4 beams out of the set A, and thus is a subset of set A. In beam management scenarios, the network device 110 may transmit the set B to the terminal device 120 to obtain field/actual measurements. Such field measurements are used to select the top N beams out of the set A to improve communication quality and system performance.

It is to be noted that, although it is shown in FIG. 1B that set B used for field measurement for AI/ML model monitoring is a subset of set A, in other examples, set B may be a set of RSs which is not comprised in the set A.

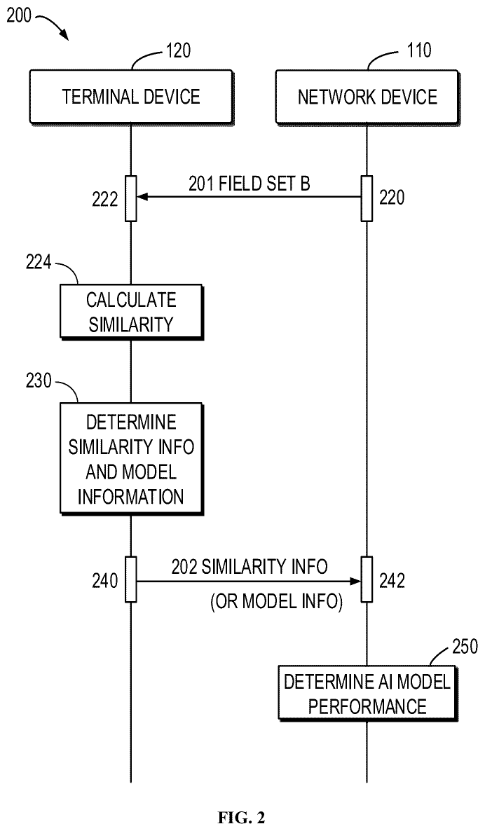

FIG. 2 illustrates an example signaling chart of a communication process 200 in accordance with some example embodiments of the present disclosure. Only for the purpose of discussion, the process 200 will be described with reference to FIG. 1. The process 200 may involve the terminal device 120 and network device 110.

In some example embodiments, the network device 110 is deployed with at least one AI/ML model. The terminal device 120 receives at least one first set of RSs from the network device 110, and each of the at least one first set of RSs corresponds to one of the at least one AI/ML model. The terminal device 120 then calculates at least one similarity based on the at least one first set of RSs. Then the terminal device 120 determines at least one similarity information based on the at least one calculated similarity, and transmits to the network device 110 at least one of: the at least one determined similarity information or at least one model information indicating an index of at least one AI/ML model.

In the example as illustrated in FIG. 2, the network device 110 transmits 220 a set of field beams (denoted as “field set B”) 201 to the terminal device 120. Here, the field set B 201 is a set of RSs like “set B” as explained with reference to FIG. 1B.

On the other side of communication, the terminal device 120 receives 222 the at least one first set of RSs (in FIG. 2, the field set B 201). Then, the terminal device 120 calculates 224 at least one similarity based on the at least one first set of RSs.

For example, the terminal device 120 calculates the similarity based on field set B 201. In this case, the network device 110 may further transmit training information of a second set of RSs (hereafter also referred to as “training set B”) associated with the first set of RSs (in FIG. 2, the field set B 201) to the terminal device 120. The second set of RSs associated with the first set of RSs may have same or alike beam parameters (for example, beam, beam direction, etc,.) as the first set of RSs, but measured in training environment to obtain the training information (also referred to as “training dataset”). On the other side of the communication, the terminal device 120 receives the training information from the network device 110. The terminal device 120 measures the field set B to obtain field measurements comprising at least one of: Layer 1—Reference Signal Received Power (L1-RSRP), Layer 1—Signal to Interference plus Noise Ratio (L1-SINR), RSRP, SINR, RSRQ or CINR. For example, the field measurements of the field set B may comprise L1-RSRP. Then the terminal device 120 calculates the Euclidean distance of a quality metric between the field measurements of the at least one first set of RSs and the training information of the at least one second set of RSs in order to obtain multiple similarities and taking the maximum similarity among the multiple similarities as the determined similarity. Here, the quality metric may be one of: L1-RSRP, L1-SINR, RSRP, SINR, reference signal receiving quality (RSRQ) or Carrier to Interference-plus-Noise Ratio (CINR). For example, the terminal device 120 calculates the Euclidean distance of L1-RSRP between the field measurements of the first set of RSs (in FIG. 2, the field set B 201) and the training information of the second set of RSs (training set B) to obtain the similarity between the two. For example, assuming that the training information comprises L1-RSRP of 100,000 samples of the training set B associated with the field set B 201. Each sample in used to calculate the Euclidean distance, as shown in Equation 1.

$$\begin{matrix}d ( x , y ) = \sqrt{( \sum {( {x}_{i} - {y}_{i} )}^{2} )} & sim ( x , y ) = \frac{1}{1 + d ( x , y )}\end{matrix} \qquad ( Equation 1 )$$

In Equation 1, xi denotes the value of field measurements of L1-RSRP of the field set B 201, yi denotes the value of L1-RSRP in the training information of the training set B associated with the field set B 201. The Euclidean distance d(x, y) of L1-RSRP between the field measurements of the field set B 201 and the training information of the training set B associated with the field set B 201 is thus calculated. Then the similarity sim(x, y) between the field measurements of the field set B 201 and the training information of the training set B associated with the field set B 201 is obtained as the reciprocal of sum of d(x, y) and 1.

Since there are 100,000 samples of the training set B associated with the field set B 201, 100,000 Euclidean distance d(x, y) and 100,000 sim(x, y) may be obtained. The terminal device 120 may then take the maximum similarity among the 100,000 similarities as the calculated similarity.

If there are multiple field set Bs, for each of the at least one first set of RSs, at least one similarity based on the at least one first set of RSs can be calculated by calculating, based on the each of the first set of RSs, similarity between the measured beam qualities of the each of the first set of RSs and the beam qualities corresponding to the each of the first set of RSs in a training dataset of the corresponding AI/ML model. In other words, for each of the at least one first set of RSs, the method to calculate the similarity can be applied to obtain the corresponding at least one similarity(ies).

It is to be noted that, the similarity between the field set B and the training set B is only used as an example. It can generally refer to the similarity between a first set of RSs and a second set of RSs associated with the first set of RSs, or measurements (e.g., RSRP/L1-RSRP/RSRQ/CIR/CINR) corresponding to the first set of RSs and measurements corresponding to the second set of RSs, or measured values of the first set of reference signals and corresponding/associated values in training dataset. Alternatively, it can refer to the similarity between a first set of RSs and a set of predefined/configured values associated with the first set of reference signals. The terminal device 120 may obtain the training information (training dataset) of the at least one second set of reference signals associated with the at least one first set of reference signals from the network device 110, core network or edge cloud (or server, other device via sidelink) configuration or provision.

Then, based on the calculated similarity, the terminal device 120 determines 230 at least one similarity information based on the calculated at least one similarity, and at least one model information corresponding to the at least one similarity information. The at least one model information indicates an index of at least one AI/ML model.

In one example, the similarity information is a first indication indicating a first state and a second state. If the calculated similarity is larger than or equal to a first threshold, the first indication indicates the first state, and if the calculated similarity is smaller than the first threshold, the first indication indicates the second state. In other words, the first state indicates that the field measurements of at least one first set of reference signals is similar as the training information of the at least one second set of reference signals associated with the at least one first set of reference signals 201, and the second state indicates that the field measurements of at least one first set of reference signals is not similar as the training information of the at least one second set of reference signals associated with the at least one first set of reference signals 201. Since there are only two different results need to be indicated, the bitwidth (or payload size) for the first indication can be 1 bit. For example, “1” may be used to indicate that the at least one first set of reference signals (for example, the field set B 201 as illustrated in FIG. 2) is similar as the at least one second set of reference signals (for example, training set B) associated with the at least one first set of reference signals, and “0” may be used to indicate that the at least one first set of reference signals (for example, the field set B 201 as illustrated in FIG. 2) is not similar as the at least one second set of reference signals (for example, training set B) associated with the at least one first set of reference signals 201. The terminal device 120 may determine, based on that the determined similarity sim(x, y) is larger than or equal to a predefined first threshold, that the field measurements of the at least one first set of reference signals 201 (for example, field set B as illustrated in FIG. 2) is similar as the training information of the at least one second set of reference signals. The terminal device 120 may determine, based on that the determined similarity sim(x, y) is smaller than the predefined first threshold, that the field measurements of the at least one first set of reference signals 201 (for example, field set B as illustrated in FIG. 2) is not similar as the training information of the at least one second set of reference signals. The predefined first threshold may be specified by the network device 110, and may be fixed and unchanged. Alternatively, the predefined first threshold may be AI/ML model specific, and it may be configured by the network device 110 through RRC/MAC-CE/DCI signaling.

In doing so, the network device 110 can determine the AI/ML model performance indirectly. In other words, the network device 110 can determine whether the AI/ML model is applicable or suitable for the current communication environment.

In some example embodiments, the similarity information is a second indication indicating a similarity level corresponding to the calculated similarity, and the payload size of the similarity information is determined based on the number of the similarity levels. In one example, the bitwidth (payload size) for the second indication can be M (M≥1) bit(s), the value of the M depends on the number of the levels of the similarity, e.g., M=┌log₂(The number of levels)┐. Here, the “┌┐” means ceiling function to round up the calculated (log₂(The number of levels) value. For example, assuming the number of levels is 4. In this case, the bitwidth (payload size) for the second indication is 2 (=log₂4) bits. And it can corresponds to 4 levels of the similarity: “Level-0: not similar”, “Level-1: low similarity”, “Level-2: high similarity” and “Level-3: fully similar”. The terminal device 120 may determine the level of the determined similarity by comparing the determined similarity and a predefined threshold. For example, for the 4 levels, 3 predefined thresholds can be specified, e.g., T1, T2 and T3.

T1, T2 and T3 can be specified, fixed or unchanged. Alternatively, they can be AI/ML model specific, and they can be configured by the network device 110 through RRC/MAC-CE/DCI signaling. The interval (i.e., range of the similarity) between the levels can be the same, and can be different, and can be specified/fixed/unchanged or configured.

TABLE 1

| The second | Level of the | Range of the |
|---|---|---|
| indicator | similarity | similarity |
| 00 | Not similar | 0 ≤ similarity ≤ T1 |
| 01 | Low similarity | T1 < similarity ≤ T2 |
| 10 | High similarity | T2 < similarity ≤ T3 |
| 11 | Fully similar | T3 < similarity ≤ 1 |

When the second indication indicates other than “fully similar”, the network device 110 may transmit additional training information to update at least one AI/ML model to the terminal device 120. On the other side of communication, the terminal device 120 may receive additional training information to update at least one AI/ML model. Specifically, if the terminal device 120 indicates “not similar” to the network device 110, in other words, if the network device 110 is indicated “not similar” as the second indication, the network device 110 can discard the AI/ML model currently used. Alternatively or additionally, the network device 110 can perform model retraining/switching. Alternatively or additionally, the network device 110 may decide not to use any AI/ML model for beam management. If the terminal device indicates “low similarity” or “high similarity” to the network device 110, in other words, if the network device 110 is indicated “low similarity” or “high similarity” as the second indicator, the network device 110 can further collect new training data to perform model updating (e.g., fine-tuning). Especially for “low similarity”, more new training data may be required because a large amount of parameters of AI/ML model need to be updated. For “high similarity”, less new training data may be required because only a few parameters of AI/ML model need to be updated. If the terminal device 120 indicates “fully similar” to the network device 110, in other words, if the network device 110 is indicated “fully similar” as the second indicator from the terminal device 120, the network device 110 can continue to use the AI/ML model currently used, and no change to the AI/ML model is required.

In some example embodiments, the similarity information is a third indication indicating the numeric value of the calculated similarity. The numeric value of the calculated similarity is a real value between 0 and 1 with the scale being 0.1. Payload size of the similarity information is determined based on the number of the scales of the similarity. For example, the third indication may indicate the similarity (e.g., 0, 0.1, 0.2, 0.3, 0.4, 0.5, 0.6, 0.7, 0.8, 0.9, 1) between the at least one first set of reference signals 201 and the at least one second set of reference signals associated with the at least one first set of reference signals 201. For example, the third indication may be the value of the calculated similarity sim(x, y) itself, ranging from 0 to 1 with the scale being 0.1, which means that, though the actually calculated similarity sim(x, y) may not be exactly one of {0, 0.1, 0.2, 0.3, 0.4, 0.5, 0.6, 0.7, 0.8, 0.9, 1}, the actually calculated similarity sim(x, y) can be rounded to {0, 0.1, 0.2, 0.3, 0.4, 0.5, 0.6, 0.7, 0.8, 0.9, 1} with the scale being 0.1. In this case, the similarity includes 11 different values, so the bitwidth (payload size) for the third indication can be determined based on: log 211, i.e., 4 bits. Here, for example, “0000” may refer to “similarity is equal to 0”, “0001” may refer to “similarity is equal to 0.1”, “0010” may refer to “similarity is equal to 0.2”, . . . “1000” may refer to “similarity is equal to 0.8”, “1001” may refer to “similarity is equal to 0.9”, and “1010” may refer to “similarity is equal to 1”. Additionally, “1011”, “1100”, “1101”, “1110” and “1111” can be reserved. In doing so, the network device 110 can obtain more accurate similarity. Accordingly, the network device 110 can determine more accurately the size of new training dataset required for model updating (e.g., fine-tuning).

After determining 230 the at least one similarity information and the corresponding at least one model information, the terminal device 120 may transmit 240 at least one of the at least one determined similarity information or at least one model information 202 to the network device 110, and the at least one model information indicates an index of at least one AI/ML model. On the other side of communication, the network device 110 may receive 242 the at least one of similarity information or the model information 202 from the terminal device 120. For example, the terminal device 120 may transmit 240 at least one of the similarity information or the model information 202 in a Channel State Information (CSI) report to the network device 110.

With the received at least one of the similarity information or the model information 202 from the terminal device 120, the network device 110 can determine 570 that the performance of at least one AI/ML model deteriorates. Then, as described above, the network device 110 may discard the AI/ML model currently used. Alternatively or additionally, the network device 110 may perform model retraining/switching. Alternatively or additionally, the network device 110 may decide not to use any AI/ML model for beam management. If the network device 110 is indicated “fully similar” from the terminal device 120, the network device 110 can continue to use the AI/ML model currently used, and no change to the AI/ML model is required.

In some example embodiments, bitwidth (payload size) of the model information is determined based on the number of the at least one AI/ML model. For example, assuming there are L (L is a positive integer) AI/ML model(s), i.e., the number of the at least one AI/ML model is L, then the bitwidth (payload size) of the model information can be determined based on L. For a specific example, bitwidth (payload size) of the model information is determined as “┌log₂L┐”. For example, assuming L=6, then bitwidth (payload size) of the model information is determined as 3.

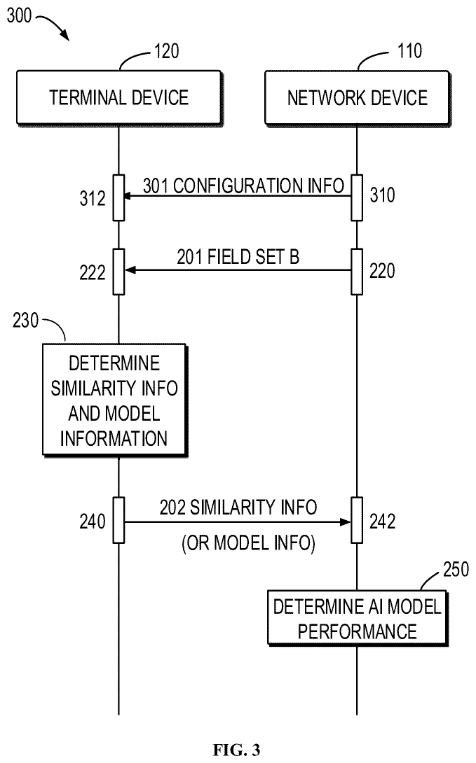

Reference is now made to FIG. 3, which illustrates a signaling chart of a communication process 300 in accordance with some example embodiments of the present disclosure. Only for the purpose of discussion, the process 300 will be described with reference to FIGS. 1 and 2. The process 300 may involve the terminal device 120 and the network device 110. For the same or like operation(s) as in process 200, description of process 200 can be referenced, so details will be omitted.

In some example embodiments, the terminal device 120 transmits at least one of the similarity information or the model information 202 to the network device 110 by: receiving, from the network device 110, configuration information for the terminal device 120 to report in a first Channel State Information (CSI) report at least one of: the at least one determined similarity information or the at least one model information; generating the CSI report comprising at least one of: the at least one determined similarity information or the at least one model information; transmitting, to the network device 110, the CSI report.

For example, as illustrated in FIG. 3, before the network device 110 transmits 220 at least one first set of RSs (field set B 201 as illustrated in FIG. 2) to the terminal device 120, the network device 110 may transmit configuration information 301 to the terminal device 120. On the other side of communication, the terminal device 120 receives 312 the configuration information 301.

In one example, the configuration information 301 may comprise a higher layer parameter to enable the terminal device 120 to perform AI/ML model monitoring. In another example, the configuration information 301 may be transmitted by the network device 110 and received by the terminal device 120 via at least one of the following: Remote Resource Control (RRC) signaling, Medium Access Control-Control Element (MAC-CE) signaling, or Downlink Control Information (DCI) signaling. In this case, the configuration information 301 may configure the terminal device 120 for reporting an event indicating that the performance of at least one AI/ML model deteriorates.

In another example, the configuration information 301 may further comprise a parameter indicating that the CSI report is used to report the at least one similarity information or the at least one model information, and the configuration information 301 may configure the terminal device 120 for reporting a CSI report comprising at least one of the similarity information or the model information 202. Specifically, the configuration information 301 may configure the terminal device 120 to report a CSI report which comprises a new report item. The new report item may be for example named as “similarity”, and at least one of the similarity information or the model information 202 can be included in this new report item in the CSI report to be reported to the network device 110.

With the configuration information 301, the terminal device can be configured for performing AI/ML model monitoring. In other words, the terminal device can be configured using the configuration information 301 with the ability to perform AI/ML model monitoring.

After being configured for performing AI/ML model monitoring and before performing AI/ML model monitoring, the terminal device 120 may report a capability information to the network device 110, and the capability information is used to indicate at least one of: the terminal device 120 supports AI/ML model monitoring, the terminal device 120 supports measuring/calculating/reporting the similarity, or a training dataset of corresponding AI/ML model is deployed at the terminal device 120. On the other side of communication, the network device 110 may receive the capability information from the terminal device 120.

In some example embodiments, after the terminal device 120 determines 230 the similarity, the terminal device 120 may, based on the configuration information 301, generate a CSI report comprising at least one of the similarity information or the model information 202, and transmit 240 the CSI report carrying the determined similarity information in the allocated PUCCH/PUSCH resources to the network device 110 as already described with reference to FIG. 2. As described above, on the other side of the communication, the network device 110 may receive 242 the CSI report.

In some example embodiments, after the network device 110 receives 242 at least one of the similarity information or the model information 202 from the terminal device 120, the network device 110 may determine 250 the performance of the AI/ML model based on the received at least one of the similarity information or model information 202, which is comprised in the CSI report.

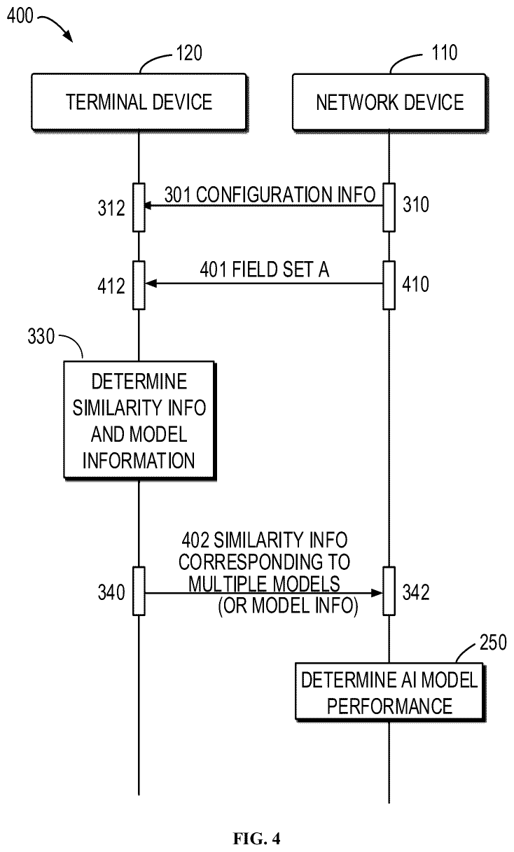

Reference is now made to FIG. 4, which illustrates a third example signaling chart of a communication process 400 in accordance with some example embodiments of the present disclosure. Only for the purpose of discussion, the process 400 will be described with reference to FIGS. 1-3. The process 400 may involve the terminal device 120 and the network device 110. For the same or like operation(s) as in process 300, description of process 300 can be referenced, so details will be omitted.

In some example embodiments, in order to predict the beam information of Set A, multiple AI/ML models may be deployed at the network device 110. Specifically, these AI/ML models may correspond to different beam patterns or groups, for example, Set B1, set B2 . . . . For simplicity concern, these set B1, set B2 and so on are called “multiple set Bs”. In order to perform model monitoring for the multiple AI/ML models, the network device 110 may transmit 410 the full Set A (or union of multiple Set B) 401 to the terminal device 120.

Then, the terminal device 120 may determine, using the same method as described with reference to FIGS. 2 and 3, the similarity corresponding to each AI/ML model, i.e., the similarity between the field Set B corresponding to the AI/ML model and the training Set B corresponding to the AI/ML model. Here, “the field Set B corresponding to the AI/ML model” implies that, the measured beam quality (e.g., L1-RSRP) of the first set of RSs is used as input of the AI/ML model. The terminal device 120 can report the similarities corresponding to the multiple AI/ML models simultaneously.

In some example embodiments, the network device 110 may transmit an AI/ML model list to the terminal device 120. The AI/ML model list may comprise at least one AI/ML model ID (hereafter also referred to as “AI/ML model index” or simply “index”). The at least one AI/ML model ID may corresponds to the at least one first set of RSs. On the other side of communication, the terminal device 120 may receive the AI/ML model list from the network device 110.

For example, the terminal device 120 may be configured with an AI/ML model (or beam pattern) list including multiple AI/ML model IDs. And each AI/ML model ID corresponds to a specific beam pattern (i.e., Set B) transmitted from the network device 110.

TABLE 2
AI/ML model list

| | |
|---|---|
| AI/ML model ID = 0: | beam-0, beam-3, beam-12, beam-15 |
| AI/ML model ID = 1: | beam-5, beam-6, beam-9, beam-10 |
| AI/ML model ID = 2: | beam-0, beam-15 |
| . | . |
| . | . |
| . | . |
| . | . |
| . | . |
| . | . |
| AI/ML model ID = N: | beam-3, beam-12 |

As shown in Table 2, there are (N+1) AI/ML models, each corresponding to a unique model ID. Each AI/ML model is associated with a set of beam (i.e., a set of RSs), like the field set B described above with reference to FIGS. 2 and 3. For example, the AI/ML model with AI/ML model ID=0 corresponds to the set of beam {beam-0, beam-3, beam-12, beam-15}, the AI/ML model with AI/ML model ID=1 corresponds to the set of beam {beam-5, beam-6, beam-9, beam-10}, the AI/ML model with AI/ML model ID=2 corresponds to the set of beam {beam-0, beam-15}, . . . , and the AI/ML model with AI/ML model ID=N corresponds to the set of beam {beam-3, beam-12}. Such sets of beams can be seen as examples of set B1, set B2, . . . , which is generally referred to as “multiple set Bs” in this disclosure.

In this case, the terminal device 120 may report multiple indications to the terminal device 110. Each of the multiple indications (i.e., similarity information) may correspond to a specific AI/ML model among the multiple AI/ML models. Each of the multiple indications may be used to indicate any one of: whether the field measurements of at least one first set of RSs is similar as the training information of the at least one second set of RSs, the level or state of the determined similarity between the field measurements of the at least one first set of RSs and training information of the at least one second set of RSs, or the similarity value between the field measurements of the at least one first set of RSs and training information of the at least one second set of RSs, the similarity value being a real value between 0 and 1. In other words, each of the multiple indications may be a first indication, a second indication or a third indication as described above.

In some example embodiments, the CSI report transmitted from the terminal device 120 to the network device 110 comprises none of the model ID of the multiple AI/ML models, and the mapping order in the CSI report of the reported at least one determined similarity information is determined based on the index of the at least one AI/ML model corresponding to the at least one determined similarity information, for example, in ascending or descending order of the AI/ML model ID, as illustrated in Table 3.

TABLE 3
similarity information comprised in CSI report

| CSI report | |
|---|---|
| number | CSI fields |
| CSI report | The indication #0 corresponds to AI/ML model ID = 0 |
| #n | The indication #1 corresponds to AI/ML model ID = 1 |
| | The indication #2 corresponds to AI/ML model ID = 2 |
| | . . . |
| | The indication #N corresponds to AI/ML model ID = N |

As shown in Table 3, in the CSI report, the CSI report number (i.e., the number of indications) is indicated in the “CSI report number” field. In this example, as shown in the “CSI fields”, each indication is given for each AI/ML model with AI/ML model ID ranging from 0 to N. In other words, there are (N+1) indications for the (N+1) AI/ML models. In this case, the CSI report number can be determined as (N+1). Therefore, if the indications for the (N+1) AI/ML models is sorted based on the corresponding AI/ML model ID in ascending order as shown in Table 3, the network device 110, upon receiving the CSI report comprising information as shown in Table 3, can be aware that there are (N+1) indications for the (N+1) AI/ML models, and can figure out each indication corresponds to an AI/ML model in ascending order of the AI/ML model ID. Since there are (N+1) indications comprised in the CSI report, the network device 110 can then figure out the indication with index 0 corresponds to the AI/ML model whose AI/ML model ID=0, and indication with index 1 corresponds to the AI/ML model whose AI/ML model ID=1, and so on.

In some example embodiments, the CSI report may comprise a first part and a second part. The first part may comprise a fourth indication indicating the first state or the second state and a fifth indication indicating the number of AI/ML model(s) whose corresponding similarity information indicates the first state or the second state. And, when the fifth indication indicates non-zero, the second part may comprise at least one of: model information indicating the index of the AI/ML model whose corresponding similarity information indicates the first state or the second state, or corresponding similarity information. The first part may be fixed payload size and the second part may be unfixed payload size.

For example, when the number of AI/ML models is large (in the example as shown in Table 2 and Table 3, (N+1)), CSI part 1 (fixed payload size) and CSI part 2 (unfixed payload size) can be applied for reporting the similarity information corresponding to the multiple (i.e., (N+1)) AI/ML models. Specifically, CSI part 1 comprises at least 2 new indications, e.g., indication-0 and indication-1. Indication-0 is used to indicate whether the field Set B corresponding to at least one AI/ML model is not similar (or similar) as the training Set B corresponding to the AI/ML model(s). Indication-1 is used to indicate the number of AI/ML models whose corresponding field Set B is not similar (or similar) as the corresponding training Set B. The bitwidth (payload size) for the indication-0 is 1 bit, and the bitwidth (payload size) for the indication-1 can be determined based on: ┌log₂(The number of AI/ML models)┐. CSI part 2 may comprise the AI/ML model IDs. CSI part 2 may also comprise corresponding similarity information.

For example, assuming that the indication-1 used to indicate the number of AI/ML models whose corresponding Set B is not similar (or fully similar) as the corresponding training Set B is 4. In this case, if the first indication as described above is adopted to indicate a field set B is not similar as its corresponding training set B for a corresponding AI/ML model, CSI part 2 may consist of 4 AI/ML model IDs. It means that the Set Bs corresponding to the 4 AI/ML models are not similar to the corresponding training Set Bs. If the second indication as described above is adopted to indicate a field set B is not similar as its corresponding training set B for a corresponding AI/ML model, CSI part 2 may consist of 4 AI/ML model IDs and corresponding similarity information (i.e., level of the similarity). It may mean that the levels corresponding to the 4 AI/ML models are not “fully similar”, in other words, the levels corresponding to the 4 AI/ML models may be “Level-0: not similar”, “Level-1: low similarity” or “Level-2: high similarity”.

If the third indication as described above is adopted to indicate a field set B is not similar as its corresponding training set B for a corresponding AI/ML model, CSI part 2 may consist of 4 AI/ML model IDs and corresponding similarity information (i.e., value of the similarity). It may mean that the values of the similarities corresponding to the 4 AI/ML models are less than a predefined threshold (e.g., the value 1).

In some example embodiments, if a CSI report carrying the similarity information collides with another CSI report carrying information other than similarity information, the CSI report carrying the similarity information is prioritized. Specifically, if the CSI report carrying the similarity information collides with another CSI report carrying information other than similarity information, the CSI report carrying the similarity information is prioritized if the similarity information in the CSI report carrying the similarity information indicates the second state. The reason why such operation(s) is proposed and the beneficial effects of such operation(s) are explained below.

AI/ML Model monitoring is likely to be a periodic behavior, so the (time domain) type of the CSI report carrying the similarity may be periodic. The CSI report carrying the similarity may collide with another periodic/semi-persistent/aperiodic CSI report carrying information other than the similarity (for example, L1-RSRP/L1-SINR or CSI). According to the existing specification, the terminal device 120 will give priority to transmitting the semi-persistent/aperiodic CSI report. However, if the AI/ML model performance deteriorates at this time and the corresponding similarity information is not reported, the network device 110 will continue to apply the currently used AI/ML model whose performance has already deteriorated, which is unexpected for model inference. Additionally, the priority of the CSI report carrying the similarity and that of the CSI report carrying L1-RSRP/L1-SINR or CSI is unclear. It is to be noted here that, two CSI reports are said to collide if the time occupancy of the physical channels scheduled to carry the CSI reports overlap in at least one OFDM symbol and are transmitted on the same carrier.

To address this issue, in some example embodiments, if a first CSI report carrying similarity-related information collides with another CSI report carrying information other than similarity information, the first CSI report is prioritized. For example, when the CSI report carrying the similarity collides with another CSI report carrying L1-RSRP/L1-SINR or CSI, the terminal device 120 may give priority to transmitting CSI report carrying the similarity, i.e., the terminal device 120 may transmit the CSI report carrying the similarity first (before transmitting the another CSI report carrying L1-RSRP/L1-SINR or CSI).

Specifically, in some example embodiments, if the first CSI report collides with another CSI report carrying information other than similarity information, the first CSI report is prioritized if the similarity information in the first CSI report indicates the second state. For example, when at least one of the following conditions is satisfied, the terminal device 120 may give priority to transmitting CSI report carrying the similarity over transmitting another CSI report carrying L1-RSRP/L1-SINR or CSI: the reported similarity information indicates that at least one “0” (the second state, which indicates “not similar”), the reported similarity information indicates at least one of “Level-0: not similar”, “Level-1: low similarity” or “Level-2: high similarity”, or the reported similarity information indicates at least one value that is less than or equal to a predefined threshold (e.g., the value 1). In other words, when the reported similarity information indicates that the field measurements are not fully similar as the training information, the terminal device 120 may give priority to transmitting the CSI report comprising the similarity information (transmitting the CSI report comprising the similarity information first and then transmitting the other CSI report which does not comprise similarity information).

In some example embodiments, in order to monitor multiple AI/ML models (i.e., multiple Set Bs in the same Set A) simultaneously, the network device 110 may transmit to the terminal device 120 the Set A (or a union of multiple Set Bs) instead of one Set B, as illustrated in FIG. 4. In this case, if the terminal device 120 reports only the similarity(ies), it will cause a waste of beam measurement resources, so in addition to the similarity(ies), the terminal device 120 can also obtain the actual/measurement best beam information and report it to the network device 110. In other words, the terminal device 120 reports the similarity information and the actual/measurement beam information simultaneously to the network device 110.

In this case, the CSI report further comprises beam information indicating a plurality of RSs, and the plurality of RS have a higher beam quality than the other RSs in a third set of RSs, the third set of RSs consists of the at least one first set of RSs. For example, for AI/ML model monitoring, the terminal device 120 can report the indication(s) and top K beams out of Set A simultaneously. For example, the top K beams can be the K beams with higher CRI/SSBRI and/or L1-RSRPs/L1-SINR value than the other beams. Here, K can be specified, fixed and unchanged, e.g., K=1. In this case, only the best beam will be reported to the network device 110. K also can be any other positive integer. In this case, multiple beams will be reported to the network device 110. Alternatively, the value of K can be indicated by higher layer parameter “nrofReportedRS”.

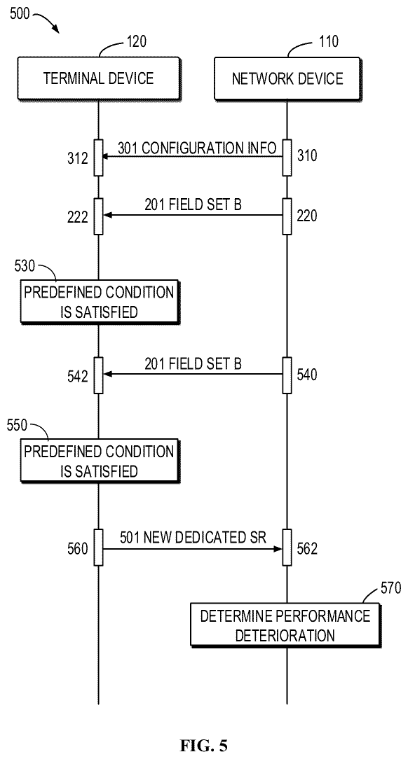

Reporting the similarity information to the network device 110 may also be event-driven. In this case, when a predefined condition is satisfied, the terminal device 120 will report an event to the network device 110. This will be elaborated with reference to FIG. 5.

FIG. 5 illustrates a fourth example signaling chart of a communication process 500 in accordance with some example embodiments of the present disclosure. Only for the purpose of discussion, the process 500 will be described with reference to FIGS. 1-3. The process 500 may involve the terminal device 120 and the network device 110. For the same or like operation(s) as in process 300 and process 400, description of process 300 and process 400 can be referenced, so details will be omitted.

In some example embodiments, the terminal device 120 may determine, the calculated similarity corresponding to the current applied AI/ML model is less than a second threshold for P1 consecutive times in a first time duration, or the calculated similarity corresponding to at least one AI/ML model is less than a third threshold for P2 consecutive times in a second time duration, P1 and P2 being positive integers; and then transmit, to the network device 110, a Scheduling Request (SR) message indicating that the calculated similarity corresponding to the current applied AI/ML model is less than the second threshold for P1 consecutive times in the first time duration, or the calculated similarity corresponding to at least one AI/ML model is less than the third threshold for P2 consecutive times in the second time duration. The sixth indication indicates whether the calculated similarity corresponding to at least one AI/ML model is larger than or equal to a fifth threshold.

For example, when the following predefined condition is satisfied, the terminal device 120 will transmit a specific event to the network device 110: the determined similarity corresponding to the AI/ML model currently applied by the network device 110 is less than or equal to a predefined threshold for P (e.g., 1, 2 or any other positive integer) consecutive times in a predefined time duration. The current AI/ML model, the predefined threshold, the P and the predefined time duration can be configured by the network device 110 through RRC/MAC-CE/DCI signaling/message. In the example illustrated in FIG. 5, P is set to be 2. The terminal device 120 receives 222 field set B from the network device 110, and determines 530 the predefined condition is satisfied for the first time. Then, the terminal device 120 receives 542 field set B from the network device 110, and determines 550 the predefined condition is satisfied for the second time. Upon determination that the predefined condition is satisfied for the second time (P=2), the event is triggered.

The event can be indicated by a new dedicated (or specified) scheduling request (SR) from the terminal device 120 to the network device 110. For example, the terminal device 120 can be provided, by the ID of the dedicated SR, a configuration for PUCCH transmission, and when the event is triggered, the terminal device 120 transmits 560 the SR 501 indicating the event on PUCCH to the network device 110. In other words, the terminal device 120 transmits a PUCCH carrying a new dedicated SR corresponding to the ID of the new dedicated SR configured by the network device 110. On the other side of the communication, the network device 110 receives 562 from the terminal device 120 the SR 501 indicating the event. The new dedicated SR 501 is used by the network device 110 to indicate that the performance of the current AI/ML model deteriorates, i.e., the above predefined condition is satisfied. In other words, the network device 110 uses the new dedicated SR 501 to determine 570 the performance of the current AI/ML model deteriorates.

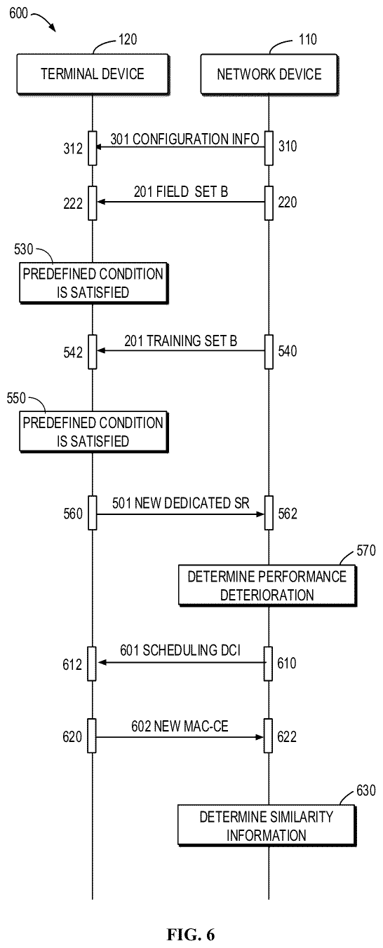

In some example embodiments, when a predefined condition is satisfied, the terminal device 120 will report to the network device 110 the event, as described above with reference to FIG. 5. Further, the terminal device 120 will report to the network device 110 the similarity information in scheduled PUSCH resource. This will be elaborated with reference to FIG. 6.

FIG. 6 illustrates a fifth example signaling chart of a communication process 600 in accordance with some example embodiments of the present disclosure. Only for the purpose of discussion, the process 600 will be described with reference to FIGS. 1 and 5. The process 600 may involve the terminal device 120 and the network device 110. For the same or like operation(s) as in process 500, description of process 500 can be referenced, so details will be omitted.

In some example embodiments, the terminal device 120 transmits, to the network device 110, a Medium Access Control-Control Element (MAC-CE) message comprising at least one of: the at least one determined similarity information, the at least one model information, or a sixth indication. The sixth indication indicates whether the calculated similarity corresponding to the AI/ML model indicated by the model information in the MAC-CE message is larger than or equal to a fifth threshold.

For example, after receiving 562 the new dedicated SR 501, the network device 110 schedules a PUSCH resource for the terminal device 120 to report the similarity information corresponding to the AI/ML model, and transmits 610 the scheduling DCI 601 to the terminal device 120, as illustrated in FIG. 6. The scheduling DCI 601 is used to schedule PUSCH resources for the terminal device 120 to report the similarity information corresponding to the new (candidate) AI/ML model(s). On the other side of the communication, the terminal device 120 receives 612 the scheduled UL resources 601 from the network device 110.

A new MAC-CE message is introduced for reporting the similarity information. In the example illustrated in FIG. 6, after receiving 612 the scheduling DCI 601, the terminal device 120 transmits 620 to the network device 110 the new MAC-CE message 602 carrying (or comprising, including) the similarity information on the PUSCH resources scheduled by the terminal device 110 via the scheduling DCI 601. On the other side of the communication, the network device 110 receives 622 the new MAC-CE message 602 from the terminal device 120. The new MAC-CE message 602 comprises at least the similarity information, e.g., level or value of similarity.

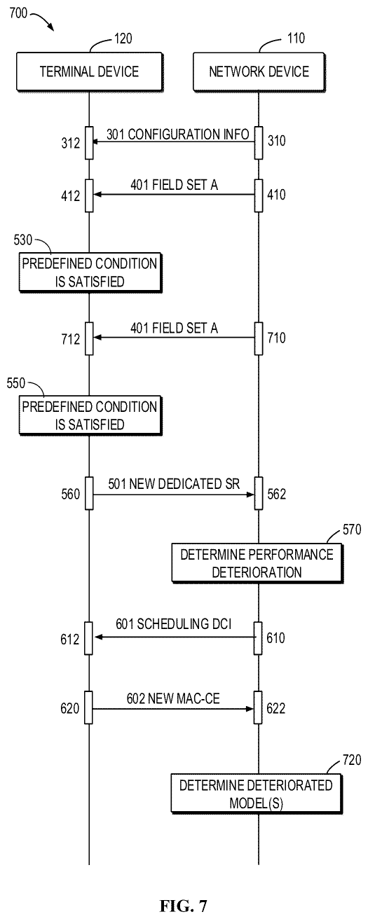

In some example embodiments, the event is not for the currently used AI/ML model, but for at least one AI/ML model(s). In this case, filed set A or union of multiple set Bs, instead of one field set B, is transmitted from the network device 110 to the terminal device 120 for the terminal device 120 to determine whether the predefined condition to trigger the event is satisfied or not. This will be elaborated with reference to FIG. 7.

FIG. 7 illustrates a sixth example signaling chart of a communication process 700 in accordance with some example embodiments of the present disclosure. Only for the purpose of discussion, the process 700 will be described with reference to FIGS. 1 and 6.

The process 700 may involve the terminal device 120 and the network device 110. For the same or like operation(s) as in process 600, description of process 600 can be referenced, so details will be omitted.

In the example illustrated in FIG. 7, when a predefined condition is satisfied, the terminal device 120 will report an event to the network device 110. Further, the terminal device 120 will report to the network device 110 the AI/ML model(s) and corresponding similarity information in scheduled PUSCH resource.

The difference between this example and the example illustrated in FIG. 6 lies in that, in FIG. 6, the field set B is used to determine the condition for triggering the event, and the event is for the one AI/ML model which is currently applied by the network device 110, while in FIG. 7, the field set A or union of multiple set Bs is used to determine the condition for triggering the event, and the event is for the at least one AI/ML model(s) which is deployed at the network device 110. In the following description, only difference will be described in detail, and for the same and like operations as in FIG. 6, reference can be made to FIG. 6 and its description.

Similar to the example illustrated in FIG. 6, the event can be indicated by a new dedicated SR. Also similar to the example illustrated in FIG. 6, when the following predefined condition is satisfied, the terminal device 120 transmits 560 to the network device 110 a specific event via a new dedicated SR 501: the determined similarity corresponding to at least one AI/ML model is less than or equal to a predefined threshold for P (e.g., 1, 2, and any other positive integer) consecutive times in a predefined time duration.

The at least one AI/ML model can also be configured by the network device 110 through RRC/MAC-CE/DCI signaling/message.

Different from the example illustrated in FIG. 6, the network device 110 transmits 410 field set A (or union of multiple field set Bs) 401 to the terminal device 120, and transmit 710 filed set A (or union of multiple field set Bs) 401 to the terminal device 120. On the other side of the communication, the terminal device 120 receives 412 the field set A (or union of multiple field set Bs) 401 from the network device 110, and determines 530 that the predefined condition is satisfied, i.e., the determined similarity corresponding to at least one AI/ML model is less than or equal to a predefined threshold for the first time. The terminal device 120 receives 712 the field set A (or union of multiple field set Bs) 401 from the network device 110, and determines 550 that the predefined condition is satisfied, i.e., the determined similarity corresponding to at least one AI/ML model is less than or equal to a predefined threshold for the second time. Upon determination that the predefined condition is satisfied for the second time (P=2), the event is triggered, and the terminal device 120 transmits 560 to the network device 110 a specific event via a new dedicated SR 501.

On the other side of communication, the network device 110 receives 562 the new dedicated SR 501 from the terminal device 120. It means that the network device 110 can determine 570 that the performance of at least one AI/ML model deteriorates based on this new dedicated SR 501.

Also similar to the example illustrated in FIG. 6, after receiving 562 the new dedicated SR, the network device 110 determines 570 the event of performance deterioration of at least one AI/ML model(s).

In order to know the performance of which AI/ML model(s) deteriorates, the network device 110 schedules PUSCH resources and transmit 610 a scheduling DCI 601 to the terminal device 120. Here, the scheduling DCI 601 is used for the terminal device 120 to report the similarity information corresponding to the at least one AI/ML model(s) whose performance deteriorates.

On the other side of the communication, the terminal device 120 receives 612 the scheduling DCI 601 from the network device 110, and then transmits 620 to the network device 110 the new MAC-CE message 602 carrying (or comprising, including) the similarity information on the PUSCH resources scheduled by the terminal device 110 via the scheduling DCI 601. On the other side of the communication, the network device 110 receives 622 the new MAC-CE message 602 from the terminal device 120. The new MAC-CE message 602 comprises at least the AI/ML model information (e.g., AI/ML model ID). And the new MAC-CE message 602 may also corresponding similarity information (e.g., level or value of similarity).

The AI/ML model(s) corresponding to the reported AI/ML model information (e.g., AI/ML model ID or AI/ML model index) comprised in the new MAC-CE message 602 refer to the AI/ML model(s) whose performance deteriorates. Therefore, the network device 630 may determine 720 the AI/ML model(s) whose performance deteriorates (and corresponding similarity(ies)) based on the received MAC-CE message 602.

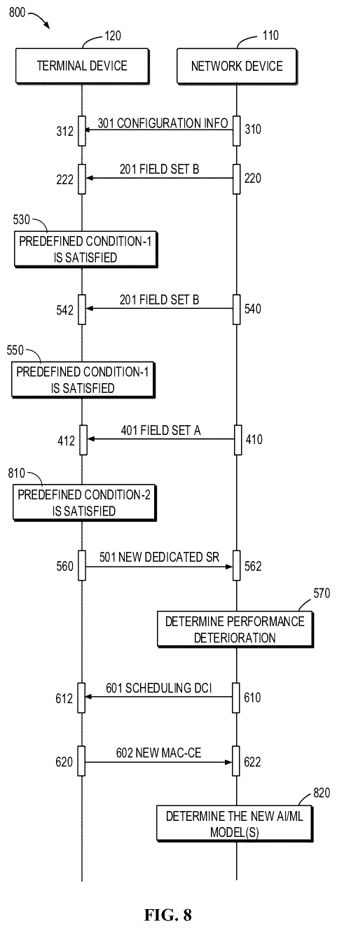

In some example embodiments, the event may involve at least one candidate AI/ML model(s). When a predefined condition is satisfied, the terminal device 120 may report to the network device 110 an event. Further, the terminal device 120 may report to the network device 110 a new AI/ML model(s) and corresponding similarity information in scheduled PUSCH resource. In this case, field set B which is corresponding to the currently used AI/ML model used by the network device 110 as well as set A or union of multiple set Bs are transmitted from the network device 110 to the terminal device 120 for the terminal device 120 to determine whether the predefined condition to trigger the event is satisfied or not. This will be elaborated with reference to FIG. 8.

FIG. 8 illustrates a seventh example signaling chart of a communication process 800 in accordance with some example embodiments of the present disclosure. Only for the purpose of discussion, the process 800 will be described with reference to FIGS. 1 and 6. The process 800 may involve the terminal device 120 and the network device 110. For the same or like operation(s) as in process 600, description of process 600 can be referenced, so details will be omitted.

In some example embodiments, the terminal device 120 may determine, the calculated similarity corresponding to the current applied AI/ML model is less than a second threshold for P1 consecutive times in a first time duration, or the calculated similarity corresponding to at least one AI/ML model is less than a third threshold for P2 consecutive times in a second time duration. P1 and P2 being positive integers. The terminal device 120 may also transmits, to the network device 110, a Scheduling Request (SR) message indicating that the calculated similarity corresponding to the current applied AI/ML model is less than the second threshold for P1 consecutive times in the first time duration, or the calculated similarity corresponding to at least one AI/ML model is less than the third threshold for P2 consecutive times in the second time duration.

In the example illustrated in FIG. 8, when a predefined condition is satisfied, the terminal device 120 will report an event to the network device 110. Further, the terminal device 120 will report to the network device 110 at least one candidate AI/ML model(s) and corresponding similarity information in scheduled PUSCH resource.

One of the differences between this example and the example illustrated in FIG. 6 is that, in FIG. 8, the predefined condition to trigger the event to report a new dedicated SR message to the network device 110 comprises a predefined condition-1 and a predefined condition-2. So the predefined condition for the terminal device 120 to transmit a specific event via the new dedicated SR message to the network device 110 could be: the determined similarity corresponding to the AI/ML model currently applied by the network device 110 is less than or equal to a second predefined threshold (predefined condition-1) for P1 (e.g., 1, 2, and so on) consecutive times in a first time duration, and in a set of candidate AI/ML models, the determined similarity corresponding to the candidate AI/ML model is larger than or equal to a third threshold (predefined condition-2) for P2 (e.g., 1, 2, and so on) consecutive times in a second time duration. In the example illustrated in FIGS. 8, P1=2 and P2=1.

In the following description, only difference will be described in detail, and for the same and like operations as in FIG. 6, reference can be made to FIG. 6 and its description.

Similar to the example illustrated in FIG. 6, the event can be indicated by a new dedicated SR.

Similar as the example illustrated in FIG. 6, the network device 110 transmits 220 field set B 201 to the terminal device 120, and transmits 540 filed set B 201 to the terminal device 120. On the other side of the communication, the terminal device 120 receives 222 the field set B 201 from the network device 110, and determines 530 that the predefined condition-1 is satisfied, i.e., the determined similarity corresponding to the AI/ML model currently applied by the network device 110 is less than or equal to a predefined second threshold (predefined condition-1) for the first time. The terminal device 120 receives 542 the field set B 201 from the network device 110, and determines 550 that the predefined condition-1 is satisfied, i.e., the determined similarity corresponding to the AI/ML model currently applied by the network device 110 is less than or equal to a predefined second threshold (predefined condition-1) for the second time.

The network device 110 transmits 410 field set A (or union of multiple field set Bs) 401 to the terminal device 120, and on the other side of the communication, the terminal device 120 receives 412 the set A (or union of multiple field set Bs) 401 from the network device 110, and determines 810 that the predefined condition-2 is satisfied, i.e., the determined similarity corresponding to at least one new (candidate) AI/ML model(s) is less than or equal to a predefined third threshold for the first time.

Upon determination that the predefined condition-1 is satisfied for the second time (P1=2) and then the predefined condition-2 is satisfied for the first time (P2=1), the event corresponding to the predefined condition is triggered, and the terminal device 120 transmits 560 to the network device 110 a specific event via a new dedicated SR 501. The new dedicated SR 501 is used to indicate that the current AI/ML model performance deteriorates, i.e., the above predefined condition is satisfied. As illustrated in FIG. 8, the network device 110 determines 570 the event of performance deterioration of the AI/ML model currently applied by the network device 110.

Similar as the example illustrated in FIG. 6 described above, after receiving the new dedicated SR 501, the network device 110 schedules a PUSCH resource for the terminal device 120 to report the similarity information corresponding to one (or multiple) new AI/ML model(s), and transmits 610 the scheduling DCI 601 to the terminal device 120. As illustrated in FIG. 8, the new AI/ML model(s) needs to satisfy the predefined condition-2. The scheduling DCI 601 is used to schedule PUSCH resources for the terminal device 120 to report the similarity information corresponding to the new AI/ML model(s). On the other side of the communication, the terminal device 120 receives 612 the scheduled UL resources 601 from the network device 110.

A new MAC-CE message is introduced for reporting the similarity information of the candidate AI/ML models. In the example illustrated in FIG. 8, after receiving 612 the scheduling DCI 601, the terminal device 120 transmits 620 to the network device 110 the new MAC-CE message 602 carrying (or comprising, including) the similarity information of the candidate AI/ML models on the PUSCH resources scheduled by the terminal device 110 via the scheduling DCI 601. On the other side of the communication, the network device 110 receives 622 the new MAC-CE message 602 from the terminal device 120. The new MAC-CE message 602 may comprise at least the candidate AI/ML model information (e.g., AI/ML model ID or AI/ML model index), and may also comprise corresponding similarity information (e.g., level or value of similarity). In addition, the new MAC-CE message 602 may also comprise at least an indication. The indication may be used to indicate that whether there is a new AI/ML model in the set of candidate AI/ML models, i.e., whether Condition-2 is satisfied. For example, the indication can comprise 1 bit. If no AI/ML model in the set of candidate AI/ML models satisfies Condition-2, the indication can be “0”. In this case, after receiving the MAC-CE message 602, the network device 110 may know that the performance of the currently used AI/ML has deteriorated and the performance of the reported new AI/ML model is good enough to be used thereafter. Then the network device 110 may perform an AI/ML model switching.

In some example embodiments, AI/ML model(s) may be deployed at the terminal device 120, instead of being deployed at the network device 110 as described above. In this case, at the terminal device 120, the lower layers (e.g., PHY) can report the similarity information to the higher layers (e.g., RRC, NAS). Accordingly, the higher layers will make decisions on model management, such as whether to continue to apply the currently used AI/ML model, perform model switching or model updating. Specifically, the higher layers can provide an indication about the decision to the lower layers to assist the lower layers to perform model management.

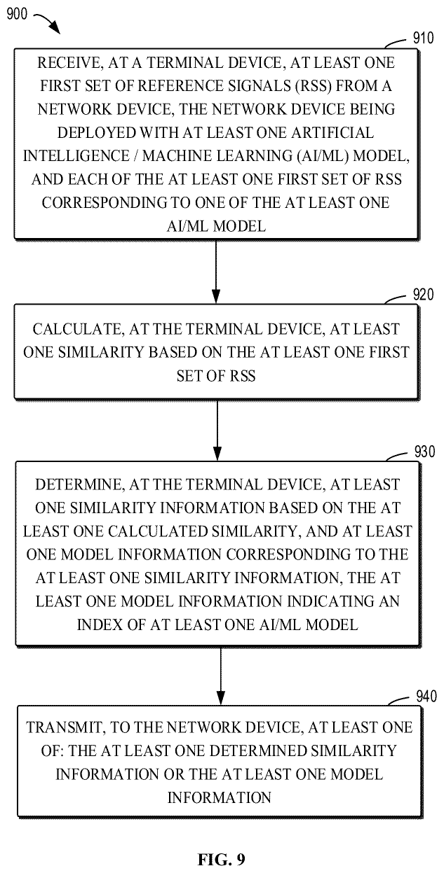

FIG. 9 illustrates a flowchart of an example method 900 implemented at a terminal device in accordance with some embodiments of the present disclosure. For the purpose of discussion, the method 900 will be described from the perspective of the terminal device 120 with reference to FIG. 1.

At block 910, the terminal device 120 receives, at a terminal device 120, at least one first set of RSs from a network device 110, and the network device 110 is deployed with at least one Artificial Intelligence/Machine Learning (AI/ML) model, and each of the at least one first set of RSs corresponds to one of the at least one AI/ML model. At block 920, the terminal device 120 calculates at least one similarity based on the at least one first set of RSs. At block 930, the terminal device 120 determines, at least one similarity information based on the at least one calculated similarity, and at least one model information corresponding to the at least one similarity information, the at least one model information indicating an index of at least one AI/ML model. The at least one model information indicates an index of at least one AI/ML model. At block 940, the terminal device 120 transmits, to the network device 110, at least one of: the at least one determined similarity information or the at least one model information.

In some example embodiments, payload size of the model information is determined based on the number of the at least one AI/ML model.

In some example embodiments, the calculating the at least one similarity based on the at least one first set of RSs comprises: for each of the at least one first set of RSs, calculating, based on the each of the first set of RSs, similarity between the measured beam qualities of the each of the first set of RSs and the beam qualities corresponding to the each of the first set of RSs in a training dataset of the corresponding AI/ML model.

In some example embodiments, the similarity information comprises a first indication indicating a first state or a second state; wherein if the calculated similarity is larger than or equal to a first threshold, the first indication indicates the first state; and if the calculated similarity is smaller than the first threshold, the first indication indicates the second state.

In some example embodiments, payload size of the similarity information is 1 bit.

In some example embodiments, the similarity information comprises a second indication indicating a similarity level corresponding to the calculated similarity.

In some example embodiments, payload size of the similarity information is determined based on the number of the similarity levels.

In some example embodiments, the similarity information comprises a third indication indicating the numeric value of the calculated similarity.

In some example embodiments, payload size of the similarity information is determined based on the number of the scales of the similarity.

In some example embodiments, the transmitting comprises: receiving, at the terminal device and from the network device, configuration information for the terminal device to report in a first Channel State Information (CSI) report at least one of: the at least one determined similarity information or the at least one model information; generating, at the terminal device, the first CSI report comprising at least one of: the at least one determined similarity information or the at least one model information; and transmitting, to the network device, the first CSI report.

In some example embodiments, the configuration information further comprises a parameter indicating that the first CSI report is used to report the at least one similarity information or the at least one model information.

In some example embodiments, mapping order in the first CSI report of the at least one determined similarity information is determined based on the index of the at least one AI/ML model corresponding to the at least one determined similarity information.

In some example embodiments, the first CSI report comprises a CSI part 1 and a CSI part 2; wherein the CSI part 1 comprises at least a fourth indication indicating the first state or the second state and a fifth indication indicating the number of AI/ML model whose corresponding similarity information indicates the first state or the second state, and when the fifth indication indicates non-zero, the CSI part 2 comprises at least one of: model information indicating the index of the AI/ML model whose corresponding similarity information indicates the first state or the second state, or corresponding similarity information.

In some example embodiments, if the first CSI report collides with another CSI report carrying information other than similarity information, the first CSI report is prioritized.

In some example embodiments, if the first CSI report collides with another CSI report carrying information other than similarity information, the first CSI report is prioritized if the similarity information in the first CSI report indicates the second state.

In some example embodiments, the first CSI report further comprises beam information indicating a plurality of RSs having a higher beam quality than the other RSs in a second set of RSs, wherein the second set of RSs consists of the at least one first set of RSs.

In some example embodiments, the terminal device 120 further determining, the calculated similarity corresponding to the current applied AI/ML model is less than a second threshold for P1 consecutive times in a first time duration, or the calculated similarity corresponding to at least one AI/ML model is less than a third threshold for P2 consecutive times in a second time duration, P1 and P2 being positive integers; and transmitting, to the network device, a Scheduling Request (SR) message indicating that the calculated similarity corresponding to the current applied AI/ML model is less than the second threshold for P1 consecutive times in the first time duration, or the calculated similarity corresponding to at least one AI/ML model is less than the third threshold for P2 consecutive times in the second time duration, in this case, the transmitting comprises: transmitting, to the network device, a Medium Access Control-Control Element (MAC-CE) message comprising at least one of: the at least one determined similarity information, the at least one model information, or a sixth indication.

In some example embodiments, the calculated similarity corresponding to the AI/ML model indicated by the model information in the MAC-CE message is larger than or equal to a fourth threshold.

In some example embodiments, the sixth indication indicates whether the calculated similarity corresponding to at least one AI/ML model is larger than or equal to a fifth threshold.

In some example embodiments, the terminal device 120 further reporting a capability information to the network device, wherein the capability information is used to indicate at least one of: the terminal device supports AI/ML model monitoring, the terminal device supports measurement of similarity, or a training dataset of corresponding AI/ML model is deployed at the terminal device.

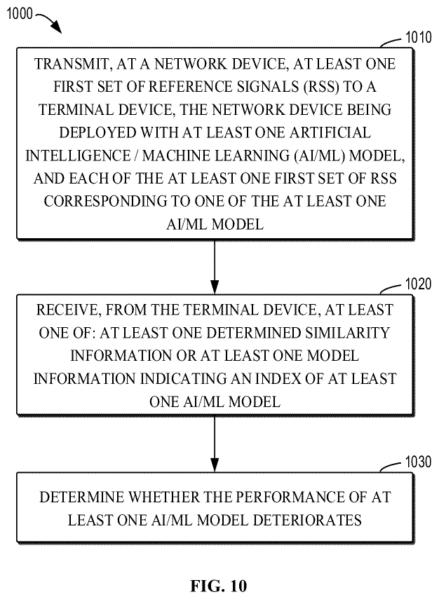

FIG. 10 illustrates a flowchart of an example method 1000 implemented at a network device in accordance with some embodiments of the present disclosure. For the purpose of discussion, the method 1000 will be described from the perspective of the network device 110 with reference to FIG. 1.

At block 1010, the network device 110 transmits at least one first set of RSs (RSs) to the terminal device 120. The network device 110 is deployed with at least one Artificial Intelligence/Machine Learning (AI/ML) model, and each of the at least one first set of RSs corresponds to one of the at least one AI/ML model. At block 1020, the network device 110 receives, from the terminal device 120, at least one of: at least one determined similarity information or at least one model information indicating an index of at least one AI/ML model. At block 1030, the terminal device 120 determines whether the performance of at least one AI/ML model deteriorates.

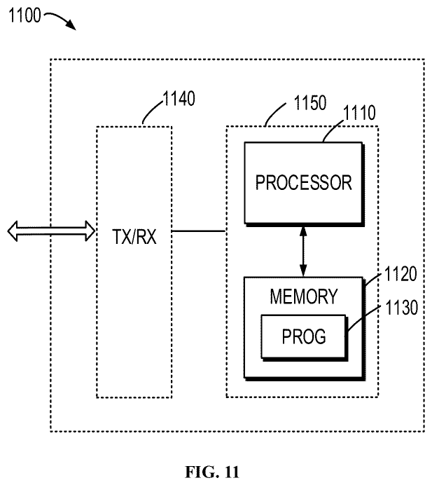

FIG. 11 illustrates a simplified block diagram of a device 1100 that is suitable for implementing embodiments of the present disclosure. The device 1100 can be considered as a further example implementation of the terminal device 120 and/or the network device 110 as shown in FIG. 1. Accordingly, the device 1100 can be implemented at or as at least a part of the terminal device 120 or the network device 110.

As shown, the device 1100 includes a processor 1510, a memory 1120 coupled to the processor 1110, a suitable transmitter (TX) and receiver (RX) 1140 coupled to the processor 1110, and a communication interface coupled to the TX/RX 1140. The memory 1110 stores at least a part of a program 1130. The TX/RX 1140 is for bidirectional communications. The TX/RX 1140 has at least one antenna to facilitate communication, though in practice an Access Node mentioned in this disclosure may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1130 is assumed to include program instructions that, when executed by the associated processor 1110, enable the device 1100 to operate in accordance with the embodiments of the present disclosure, as discussed herein with reference to FIGS. 2-10. The embodiments herein may be implemented by computer software executable by the processor 1110 of the device 1100, or by hardware, or by a combination of software and hardware. The processor 1110 may be configured to implement various embodiments of the present disclosure. Furthermore, a combination of the processor 1110 and memory 1120 may form processing means 1550 adapted to implement various embodiments of the present disclosure.

The memory 1120 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1120 is shown in the device 1100, there may be several physically distinct memory modules in the device 1100. The processor 1110 may be of any type suitable to the local technical network, and may include one or more of general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

In summary, embodiments of the present disclosure may provide the following solutions.

The present disclosure provides a method of communication, comprises: receiving, at a terminal device, at least one first set of RSs from a network device, the network device being deployed with at least one Artificial Intelligence/Machine Learning (AI/ML) model, and each of the at least one first set of RSs corresponding to one of the at least one AI/ML model; calculating, at the terminal device, at least one similarity based on the at least one first set of RSs; determining, at the terminal device, at least one similarity information based on the at least one calculated similarity, and at least one model information corresponding to the at least one similarity information, the at least one model information indicating an index of at least one AI/ML model; and transmitting, to the network device, at least one of: the at least one determined similarity information or the at least one model information.

In one embodiment, the method as above, payload size of the model information is determined based on the number of the at least one AI/ML model.

In one embodiment, the method as above, the calculating the at least one similarity based on the at least one first set of RSs comprises: for each of the at least one first set of RSs, calculating, based on the each of the first set of RSs, similarity between the measured beam qualities of the each of the first set of RSs and the beam qualities corresponding to the each of the first set of RSs in a training dataset of the corresponding AI/ML model.

In one embodiment, the method as above, the similarity information comprises a first indication indicating a first state or a second state; wherein if the calculated similarity is larger than or equal to a first threshold, the first indication indicates the first state; and if the calculated similarity is smaller than the first threshold, the first indication indicates the second state.

In one embodiment, the method as above, payload size of the similarity information is 1 bit.

In one embodiment, the method as above, the similarity information comprises a second indication indicating a similarity level corresponding to the calculated similarity.

In one embodiment, the method as above, payload size of the similarity information is determined based on the number of the similarity levels.

In one embodiment, the method as above, the similarity information comprises a third indication indicating the numeric value of the calculated similarity.

In one embodiment, the method as above, payload size of the similarity information is determined based on the number of the scales of the similarity x.

In one embodiment, the method as above, the transmitting comprises: receiving, at the terminal device and from the network device, configuration information for the terminal device to report in a first Channel State Information (CSI) report at least one of: the at least one determined similarity information or the at least one model information; generating, at the terminal device, the first CSI report comprising at least one of: the at least one determined similarity information or the at least one model information; and transmitting, to the network device, the first CSI report.

In one embodiment, the method as above, the configuration information further comprises a parameter indicating that the first CSI report is used to report the at least one similarity information or the at least one model information.

In one embodiment, the method as above, mapping order in the first CSI report of the at least one determined similarity information is determined based on the index of the at least one AI/ML model corresponding to the at least one determined similarity information.

In one embodiment, the method as above, the first CSI report comprises a CSI part 1 and a CSI part 2; wherein the CSI part 1 comprises at least a fourth indication indicating the first state or the second state and a fifth indication indicating the number of AI/ML model whose corresponding similarity information indicates the first state or the second state, and when the fifth indication indicates non-zero, the CSI part 2 comprises at least one of: model information indicating the index of the AI/ML model whose corresponding similarity information indicates the first state or the second state, or corresponding similarity information.

In one embodiment, the method as above, if the first CSI report collides with another CSI report carrying information other than similarity information, the first CSI report is prioritized.

In one embodiment, the method as above, if the first CSI report collides with another CSI report carrying information other than similarity information, the first CSI report is prioritized if the similarity information in the first CSI report indicates the second state.

In one embodiment, the method as above, the first CSI report further comprises beam information indicating a plurality of RSs having a higher beam quality than the other RSs in a second set of RSs, wherein the second set of RSs consists of the at least one first set of RSs.

In one embodiment, the method as above, further comprising: determining, the calculated similarity corresponding to the current applied AI/ML model is less than a second threshold for P1 consecutive times in a first time duration, or the calculated similarity corresponding to at least one AI/ML model is less than a third threshold for P2 consecutive times in a second time duration, P1 and P2 being positive integers; and transmitting, to the network device, a Scheduling Request (SR) message indicating that the calculated similarity corresponding to the current applied AI/ML model is less than the second threshold for P1 consecutive times in the first time duration, or the calculated similarity corresponding to at least one AI/ML model is less than the third threshold for P2 consecutive times in the second time duration, wherein the transmitting comprises: transmitting, to the network device, a Medium Access Control-Control Element (MAC-CE) message comprising at least one of: the at least one determined similarity information, the at least one model information, or a sixth indication.

In one embodiment, the method as above, the calculated similarity corresponding to the AI/ML model indicated by the model information in the MAC-CE message is larger than or equal to a fourth threshold.

In one embodiment, the method as above, the sixth indication indicates whether the calculated similarity corresponding to at least one AI/ML model is larger than or equal to a fifth threshold.

In one embodiment, the method as above, further comprising: reporting a capability information to the network device, wherein the capability information is used to indicate at least one of: the terminal device supports AI/ML model monitoring, the terminal device supports measurement of similarity, or a training dataset of corresponding AI/ML model is deployed at the terminal device.

The present disclosure provides a method for communication, comprises: transmitting, at a network device, at least one first set of RSs to a terminal device, the network device being deployed with at least one Artificial Intelligence/Machine Learning (AI/ML) model, and each of the at least one first set of RSs corresponding to one of the at least one AI/ML model; receiving, from the terminal device, at least one of: at least one determined similarity information or at least one model information indicating an index of at least one AI/ML model; and determining whether the performance of at least one AI/ML model deteriorates.

The present disclosure provides a terminal device, comprising: a processor; and a memory storing computer program codes; the memory and the computer program codes configured to, with the processor, cause the terminal device to perform the method implemented at the terminal device 120 discussed above.

The present disclosure provides a network device, comprising: a processor; and a memory storing computer program codes; the memory and the computer program codes configured to, with the processor, cause the network device to perform the method implemented at the network device 110 discussed above.

The present disclosure provides a computer readable medium having instructions stored thereon, the instructions, when executed by a processor of an apparatus, causing the apparatus to perform the method implemented at the terminal device 120 or the network device 110 discussed above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 6-20. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method for communication, comprising:
receiving, at a terminal device, at least one first set of Reference Signals (RSs) from a network device, the network device being deployed with at least one Artificial Intelligence/Machine Learning (AI/ML) model, and each of the at least one first set of RSs corresponding to one of the at least one AI/ML model;
calculating, at the terminal device, at least one similarity based on the at least one first set of RSs;
determining, at the terminal device, at least one similarity information based on the at least one calculated similarity, and at least one model information corresponding to the at least one similarity information, the at least one model information indicating an index of at least one AI/ML model; and
transmitting, to the network device, at least one of: the at least one determined similarity information or the at least one model information.

2. The method of claim 1, wherein payload size of the model information is determined based on the number of the at least one AI/ML model.

3. The method of claim 1, wherein the calculating the at least one similarity based on the at least one first set of RSs comprises: for each of the at least one first set of RSS,
calculating, based on the each of the first set of RSs, similarity between the measured beam qualities of the each of the first set of RSs and the beam qualities corresponding to the each of the first set of RSs in a training dataset of the corresponding AI/ML model.

4. The method of claim 1, wherein
the similarity information comprises a first indication indicating a first state or a second state;
wherein if the calculated similarity is larger than or equal to a first threshold, the first indication indicates the first state; and
if the calculated similarity is smaller than the first threshold, the first indication indicates the second state.

5. The method of claim 4, wherein payload size of the similarity information is 1 bit.

6. The method of claim 1, wherein the similarity information comprises a second indication indicating a similarity level corresponding to the calculated similarity.

7. The method of claim 6, wherein payload size of the similarity information is determined based on the number of the similarity levels.

8. The method of claim 1, wherein the similarity information comprises a third indication indicating the numeric value of the calculated similarity.

9. The method of claim 8, wherein payload size of the similarity information is determined based on the number of the scales of the similarity.

10. The method of any of claims 1-9, wherein the transmitting comprises:
receiving, at the terminal device and from the network device, configuration information for the terminal device to report in a first Channel State Information (CSI) report at least one of: the at least one determined similarity information or the at least one model information;
generating, at the terminal device, the first CSI report comprising at least one of: the at least one determined similarity information or the at least one model information;
transmitting, to the network device, the first CSI report.

11. The method of claim 10, wherein the configuration information further comprises a parameter indicating that the first CSI report is used to report the at least one similarity information or the at least one model information.

12. The method of claim 10, wherein mapping order in the first CSI report of the at least one determined similarity information is determined based on the index of the at least one AI/ML model corresponding to the at least one determined similarity information.

13. The method of claim 10,
wherein the first CSI report comprises a CSI part 1 and a CSI part 2;
wherein the CSI part 1 comprises at least a fourth indication indicating the first state or the second state and a fifth indication indicating the number of AI/ML model whose corresponding similarity information indicates the first state or the second state, and
when the fifth indication indicates non-zero, the CSI part 2 comprises at least one of:
model information indicating the index of the AI/ML model whose corresponding similarity information indicates the first state, or
the second state, or corresponding similarity information.

14. The method of claim 10, wherein if the first CSI report collides with another CSI report carrying information other than similarity information, the first CSI report is prioritized.

15. The method of claim 14, wherein if the first CSI report collides with another CSI report carrying information other than similarity information, the first CSI report is prioritized if the similarity information in the first CSI report indicates the second state.

16. The method of claim 10, wherein the first CSI report further comprises beam information indicating a plurality of RSs having a higher beam quality than the other RSs in a second set of RSs, wherein the second set of RSs consists of the at least one first set of RSs.

17. The method of any of claims 1-9, further comprising:
determining, the calculated similarity corresponding to the current applied AI/ML model is less than a second threshold for P1 consecutive times in a first time duration, or the calculated similarity corresponding to at least one AI/ML model is less than a third threshold for P2 consecutive times in a second time duration, P1 and P2 being positive integers; and
transmitting, to the network device, a Scheduling Request (SR) message indicating that the calculated similarity corresponding to the current applied AI/ML model is less than the second threshold for P1 consecutive times in the first time duration, or the calculated similarity corresponding to at least one AI/ML model is less than the third threshold for P2 consecutive times in the second time duration,
wherein the transmitting comprises:
transmitting, to the network device, a Medium Access Control-Control Element (MAC-CE) message comprising at least one of: the at least one determined similarity information, the at least one model information, or a sixth indication.

18. The method of claim 17, wherein the calculated similarity corresponding to the AI/ML model indicated by the model information in the MAC-CE message is larger than or equal to a fourth threshold.

19. The method of claim 17, wherein the sixth indication indicates whether the calculated similarity corresponding to at least one AI/ML model is larger than or equal to a fifth threshold.

20. The method of claim 1, further comprising:
reporting a capability information to the network device,
wherein the capability information is used to indicate at least one of:
the terminal device supports AI/ML model monitoring,
the terminal device supports measurement of similarity, or
a training dataset of corresponding AI/ML model is deployed at the terminal device.

21. A method for communication, comprising:
transmitting, at a network device, at least one first set of reference signals (RSs) to a terminal device, the network device being deployed with at least one Artificial Intelligence/Machine Learning (AI/ML) model, and each of the at least one first set of RSs corresponding to one of the at least one AI/ML model;
receiving, from the terminal device, at least one of: at least one determined similarity information or at least one model information indicating an index of at least one AI/ML model; and
determining whether the performance of at least one AI/ML model deteriorates.
